(19) United States
(12) Patent Application Publication
(10) Pub. No.: US 2006/0241980 A1
(43) Pub. Date: Oct. 26, 2006

(54) Medical professional liability policy with independent limits of indemnification for different categories of damages

(76) Inventor: David A. Martin, Bentleyville, OH (US)

Correspondence Address: Daniel A. Thomson;Brouse McDowell, LPA, Ste. 500, 388 S. Main Street, Akron, OH, 44311-4407, US

(21) Appl. No.: 11/103,066

(22) Filed: Apr. 11, 2005

(51) Int. Cl. B42D 15/00; G06Q 40/00

(52) U.S. Cl. 705/4; 283/54

(57) ABSTRACT

A new and improved method for establishing independent limits of indemnification for different categories of damages is herein disclosed. A medical professional liability insurance policy includes a first coverage amount for damages awarded for pain and suffering and a second coverage amount for economic damages.

### I. BACKGROUND OF THE INVENTION

A. Field of the Invention

This invention relates to the art of medical professional liability insurance, and more particularly to establishing independent limits of indemnification for different categories of damages.

B. Description of the Related Art

The desire to evaluate and change the professional liability insurance problem is well known. Various states have passed laws attempting to deal with, and fix the problem of escalating insurance premiums of professional liability insurance.

Under Ohio's new law, maximum damages for “pain and suffering” are capped at $350,000.00 in most cases, and $500,000.00 in catastrophic cases. Economic damages are not limited by the law. Insurance companies fear that the Supreme Court of Ohio may overturn the law, and strike down the new limits of liability for “pain and suffering,” thus exposing them and their client physicians to larger court awards for these damages. If the policy/insuring agreement were to limit the damages per category, the insurer would face less exposure, and thereby reduce the likelihood of paying more than $350,000.00 on behalf of a defendant in indemnification for “pain and suffering damages” (non-economic damages), regardless of what the Supreme Court of Ohio does with the new law.

The present invention provides a new and improved method for containing the cost of professional liability insurance, and overcomes certain difficulties inherent in the related inventions while providing better overall results.

### II. DEFINITIONS

To assist the reader in understanding the description of this invention, the definitions of the following terms should be noted.
Aggregate coverage amount—the total monetary value that an insurance provider will pay to a policyholder over the course of the term of the insurance policy.
Allocated loss adjustment expenses—include the following items: i. Surveillance expenses; ii. Fixed amounts for medical cost containment expenses; iii. Litigation management expenses; iv. Loss adjustment expenses for participation in voluntary and involuntary market pools if reported by accident year; v. Fees or salaries for appraisers, private investigators, hearing representatives, re-inspectors and fraud investigators, if working in defense of a claim, and fees or salaries for rehabilitation nurses, if such cost is not included in losses; vi. Attorney fees incurred owing to a duty to defend, even when other coverage does not exist; and vii. The cost of engaging experts.
Captive insurance company—an insurance provider that is owned and/or controlled by the entity that is being insured.
Coverage amount—the total monetary value that an insurance provider will pay to, or on behalf of, a policyholder for each incident and/or claim.
Deductible—The amount of loss paid by the policyholder before the insurance policy benefits become payable.
Insurance jurisdiction—a region under the regulatory control of an insurance regulatory agency.
Loss adjustment expenses: Payments by an insurance provider for the investigation and settling of claims. They also include the cost of defending a lawsuit in court.
Loss Amount—the monetary value to restore the party suffering a loss, in whole or in part, by payment, repair, or replacement.
Reinsurance—(1) A contract of indemnity against liability by which the insurance provider procures another insurance to insure against loss or liability by reason of the original insurance; (2) Insurance by one insurance provider of all or part of a risk accepted by it with another insurance provider which agrees to reimburse the insurance provider for the portion of the claim insured.

### III. SUMMARY OF THE INVENTION

In accordance with one aspect of the present invention, a medical professional liability insurance policy includes a first coverage amount for damages awarded for pain and suffering, a second coverage amount for economic damages, and a third coverage amount for damages other than pain and suffering and economic damages.

In accordance with another aspect of the present invention, a category of claims is chosen from the group comprising: pain and suffering damages, economic damages, loss adjustment expenses, and allocated loss adjustment expenses.

Still other benefits and advantages of the invention will become apparent to those skilled in the art upon a reading and understanding of the following detailed specification.

### IV. DESCRIPTION OF THE INVENTION

Currently, all professional liability policies offer one limit of coverage per claim ($1,000,000.00 in most policies for physicians, for all damages combined). One embodiment of the present invention is a professional liability insurance policy that offers independent limits of indemnification for different categories of damages. For example, an independent limit of indemnification would be provided for “pain and suffering damages,” and for “economic damages.” Independent limits of indemnification could also be offered for “Loss Adjustment Expenses” and “Allocated Loss Adjustment Expenses” as well as other categories within the Professional Liability Policy.

The following examples are provided as illustrations of the invention, but are not intended to limit the invention in any manner.

### EXAMPLE 1

A medical malpractice insurance policy containing limits, as follows: $750,000 for economic damages and $250,000 for pain and suffering damages. So, for example, if a fact finder awarded damages in the amount of $600,000 for lost wages and $400,000 for pain and suffering, the insurance policy would cover all of the lost wages amount, but only $250,000 of the pain and suffering damages. Under most existing policies, the total coverage, which for physicians is typically $1,000,000 per claim, the entire $1,000,000 would have been paid, but under the policy in this example, only $850,000 would be paid.

### EXAMPLE 2

A medical malpractice insurance policy containing limits, as follows: $500,000 for economic damages and $500,000 for pain and suffering damages. So, for example, if a fact finder awarded damages in the amount of $600,000 for lost wages and $400,000 for pain and suffering, the insurance policy would cover all of the pain and suffering amount, but only $500,000 of the lost wages amount. Under most existing policies, the total coverage, which for physicians is typically $1,000,000 per claim, the entire $1,000,000 would have been paid, but under the policy in this example, only $900,000 would be paid.

### EXAMPLE 3

A medical malpractice insurance policy containing limits, as follows: $1,000,000 coverage per claim with a maximum of $3,000,000 total. The policy limits economic damages to $750,000 for claim, with a maximum of $2,250,000 total for economic damages, and limits pain and suffering to $250,000 per claim, with a maximum of $750,000 total for pain and suffering. So, for example, in a first lawsuit, if a fact finder awarded damages in the amount of $600,000 for lost wages and $400,000 for pain and suffering, the insurance policy would cover all of the lost wages amount, but only $250,000 of the pain and suffering. In a second lawsuit, if a fact finder awarded damages in the amount of $800,000 for economic damages and $200,000 for pain and suffering, the insurance policy would cover all of the pain and suffering damages, but only $750,000 of the economic damages. In a third lawsuit, if a fact finder awarded damages in the amount of $500,000 for economic damages and $500,000 for pain and suffering, the insurance policy would cover all of the economic damages, but only $250,000 of the pain and suffering damages. At this point, the policy has paid $1,850,000 in economic damages and $700,000 in pain and suffering, for a total payment of $2,550,000. The policy will still cover the physician for up to $400,000 in economic damages, and up to $50,000 in pain and suffering damages. Under most existing policies, the total coverage, which for physicians is typically $1,000,000 per claim, the entire $3,000,000 would have been paid.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A medical professional liability insurance policy comprising:
a first coverage amount for damages awarded for pain and suffering; and, a second coverage amount for economic damages.

2. The insurance policy of claim 1, wherein the policy further comprises a third coverage amount for damages other than pain and suffering and economic damages.
